(19) United States
(12) Patent Application Publication
(10) Pub. No.: US 2012/0208163 A1
(43) Pub. Date: Aug. 16, 2012

(54) COLLABORATIVE INSTRUCTIONAL METHOD AND SYSTEM

(76) Inventors: Karen E. Dwyer, Olney, MD (US); Theresa A. Cepaitis, Montgomery Village, MD (US); Carrie D. Booth, Silver Spring, MD (US); Margaret M. Gaudino, New Market, MD (US); Gary P. Smith, Germantown, MD (US); Richard M. Jolles, Montgomery Village, MD (US); David K. Kreisberg, Bethesda, MD (US); Vivian C. Rosskamm, Potomac, MD (US); Andrew W. Miller, Frederick, MD (US); Maria L. Tarasuk, Silver Spring, MD (US)

(21) Appl. No.: 13/098,108

(22) Filed: Apr. 29, 2011

Related U.S. Application Data
(60) Provisional application No. 61/442,602, filed on Feb. 14, 2011.

(51) Int. Cl. G09B 19/00

(52) U.S. Cl. 434/322

(57) ABSTRACT

A system and method for comprehensive, fully or partially automated instructional plan creation, management, and tracking is provided. Variations of the system may include specialized computer systems, specialized applications, or web-based server-side solutions. Variations of the method may include generation of integrated or course-based instructional plans based on a relationship between standards and indicators of educational success and an academic schedule divided into schedule units. Instructional plans may be populated with learning and teaching resources from a content repository. Such population may be automated, customized, based on user settings, and otherwise configurable on a per-instructor basis. Instructors may also load content into the repository, associate content with one or more identifying parameters, and collaborate with each-other based on teaching style and resource choices.

### BACKGROUND OF THE INVENTION

1. Field of the Invention

The present invention relates generally to learning and education as well as the systems and methods associated with enabling and enhancing instructional delivery. The present invention relates more specifically to collaborative and customizable lesson plan development and management tools and methods and to systems and platforms for educational content creation, delivery, sharing, and tracking.

2. Description of Related Art

Currently, e-learning systems and online/web-based educational tools are either focused on direct content delivery (video lectures, online presentations, online testing) or act as mere content repositories or virtual bookshelves and mailboxes for teachers and students. Although useful in making certain content accessible and in enabling students to submit assignments to, and interact with, their teachers via remote, asynchronous communication, such systems are merely tools added to a traditional education approach. In such conventional systems, there are no overarching standards, cross-topic synergies, or specific educational criteria governing the organization and interaction of content or the sharing of educational resources between teachers. There are also no collaborative education delivery models on which teachers in different schools can collaborate and through which they can exchange information and resources based not only on general subject matter but also based on particular portions of one or more courses or subject areas.

### SUMMARY OF THE INVENTION

In view of the foregoing problems, it would be an advance in the state of the art of educational systems and information exchange platforms to provide a collaborative education delivery system based on a common set of standards and guidelines to enable educators to collaborate, interact and exchange information and resources more effectively. Aspects of the present invention are therefore directed at solving the above-noted problems of educator collaboration and customized education delivery in standards-based learning management, lesson-planning and education information systems.

One aspect of the present invention is directed to a system for creating and managing courses, instructional and professional development resources, and instructional plans. Such a system may include a course repository that stores course information. A course itself may be related to one or more content areas. For example, interdisciplinary and/or content-integrated elementary courses may include a broad range of content areas, such as math, reading, art, etc. By contrast, subject-specific courses, such as, for example, secondary courses, may include only one or two content areas, such as a course specifically directed towards Algebra or American history.

Each course may also have one or more thinking and academic success skills (TASS) associated with it. In an elementary course, a set of TASS may be mapped to a set of content areas such that one or more content areas may be related to one or more TASS. In a secondary course, a pool of TASS may be connected to various individual courses (and their associated content areas) such that an overarching set of TASS is associated with an assortment of individual courses. The TASS and/or the TASS-to-content or TASS-to-course mapping may be stored in a TASS repository that may be logically and/or physically distinct from the course repository.

Courses and content areas may also be associated with a schedule that indicates a unit sequence for content delivery and course pacing. In an elementary course, there may be an overarching schedule for the course with unit sequences for each of the content areas. Such an arrangement allows for consistent and uniform presentation timelines for content and enables collaboration between teachers in disparate classrooms and disparate schools because the subject matter scheduled for presentation in any given time period (week, month, quarter, semester, etc.) is uniform across all schools and classrooms presenting a particular course.

A similar approach may be used for secondary courses, with each course having an associated unit schedule that facilitates the creation of an instructional plan for delivering instruction to students. Such a solution allows for the same instructional resources to be associated with both basic and advanced courses, the difference in pacing and course density being specified by the instructional plan. In such a case, basic geometry resources may be associated with instructional plans for both geometry and advanced geometry courses, with the unit schedule specifying a much more aggressive pace of instruction for the basic geometry aspects in the advanced geometry course than in the geometry course. Such plans and associations may be stored in the course repository or may be stored in a schedule repository that is logically and/or physically distinct from the course repository.

Such a system may also include one or more resource repositories that have lesson plans, teaching tools, supplemental materials, problem sets, and other materials related to specific TASS, courses and/or content areas. In an elementary course, some resources may be content-specific or interdisciplinary and associated with particular course. Other resources may be directed to specific content areas and suitable for a range of courses incorporating that content. In secondary courses, problem sets, lesson plans, and teaching tools may be tied to a specific course (i.e. Algebra) whereas supplemental materials and other subject-specific content resources may be tied to a TASS or related courses. A basic calculus problem set may be associated with only an introductory calculus course, whereas excerpts of relevant material from calculus textbooks may be associated with introductory calculus and advanced placement calculus courses.

Elementary courses may include a curriculum integration section that has information about the comprehensive curriculum. This information may include a listing of associations between resources, unit sequences, TASS, and content areas. Secondary courses may also include such association listings, but this information may be dynamically compiled and created on demand instead of being permanently stored on an ongoing basis.

The elementary integrated curriculum may associate an instructional plan with one or more unit sequences for a content area or set of content areas and identify relevant resources by unit sequence period. In an elementary setting, the integrated curriculum enables measurement of TASS by content area within a course by associating TASS information with content area information throughout a unit sequence.

Another variation of an academic planning system may include collaborative, interactive aspects based on a set of standards and indicators and an academic schedule and sequence associated with the standards and indicators. A course structure can then be developed based on a desired course pacing and the association of course-specific standards and indicators with particular schedule units (i.e. weeks, months, quarters, semesters, etc.).

Such a course structure may then serve as the basis for one or instructional plans. An instructional plan may include a set of resources drawn from a resource pool. The resource pool may be a pool of information including magazine articles, websites, interactive exercises, questions, video clips, audio clips, books and book excerpts, and a range of other instructional materials. Materials are drawn from the resource pool into the instructional plan based on the TASS, course, and/or standards and indicators associated with a particular resource, the schedule associated with the course, and other settings such as teacher preferences, system defaults, and content indicators that may suggest the inclusion of certain resources in an instructional plan for a particular course.

In some variations, a teacher may add or remove lesson resources from an instructional plan or may upload new resources to the resource pool. These tasks may be accomplished through a user interface that enables teachers to search for resources, add those resources to an instructional plan, remove resources from an instructional plan, create customized associations between a resource and certain TASS, courses, and/or standards and indicators, post comments and ratings to a resource, and upload resources to the resource pool. In some variations of such a tool, each set of associations for a resource may be maintained so that each teacher can make their own preferred set of associations and so that incorrect or otherwise unsuitable associations can be identified and removed.

For locating and adding resources, the system may be equipped with a filtering tool accessible either from the above user interface or via some other way. Such a tool may be configured to enable searches for resources based on media type, keywords, author/uploader, current and/or past associations, upload or publication date, content, and other relevant factors.

Other aspects of the present invention are directed to methods of creating and managing courses, resources, instructional plans and the associated systems thereof as discussed above.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF DRAWINGS

The present invention will become more fully understood from the detailed description given hereinbelow and the accompanying drawings which are given by way of illustration only, and thus are not limitative of the present invention, and wherein

FIG. 1 depicts a computer system configured to store, access, update, and present curriculum and course data according to various concepts of the invention;

FIG. 2 depicts a high-level architecture of a database access and control system according to various concepts of the invention;

FIG. 3a depicts an embodiment of a set of standards and indicators for a content area;

FIG. 3b depicts an embodiment of an academic skills list mapped to unit schedules across grade levels according to various concepts of the invention;

FIG. 4a depicts an embodiment of a mapping of content areas, academic skills, and unit schedules, and the integration thereof, according to various concepts of the invention;

FIG. 4b depicts a screen shot of an embodiment of an interface for a instructional planning tool according to various concepts of the invention;

FIG. 4c depicts an embodiment of an instructional plan showing associations between indicators and particular topics within content areas during a schedule according to various concepts of the invention;

FIG. 4d depicts an embodiment of an instructional plan for a particular day showing associations between indicators and particular learning activities;

FIG. 4e depicts a screen shot of an embodiment of an interface for an instructional planning tool according to various concepts of the invention;

FIG. 4f depicts an embodiment of an association diagram showing connections between standards and indicators and essential questions;

FIG. 4g depicts a screen shot of an embodiment of a comparison tool aspect of an instructional planning tool according to various concepts of the invention;

FIG. 4h depicts a screen shot of an embodiment of a comparison tool aspect of an instructional planning tool according to various concepts of the invention;

FIG. 4i depicts a screen shot of an embodiment of an interface for an educational resource management tool according to various concepts of the invention;

FIG. 4j depicts a screen shot of an embodiment for a resource rating utility in an instructional planning tool according to various concepts of the invention;

FIG. 5a depicts a high-level data diagram of an instructional plan creation method according to various concepts of the invention;

FIG. 5b depicts a high-level data diagram of an instructional plan creation method according to various concepts of the invention;

FIG. 5c depicts a high-level data diagram of a content plan creation method according to various concepts of the invention; and

FIG. 5d depicts a high-level flowchart for an instructional plan creation workflow method according to various concepts of the invention.

The drawings will be described in detail in the course of the detailed description of the invention.

### DETAILED DESCRIPTION OF THE INVENTION

The following detailed description of the invention refers to the accompanying drawings. The same reference numbers in different drawings identify the same or similar elements. Also, the following detailed description does not limit the invention. Instead, the scope of the invention is defined by the appended claims and equivalents thereof.

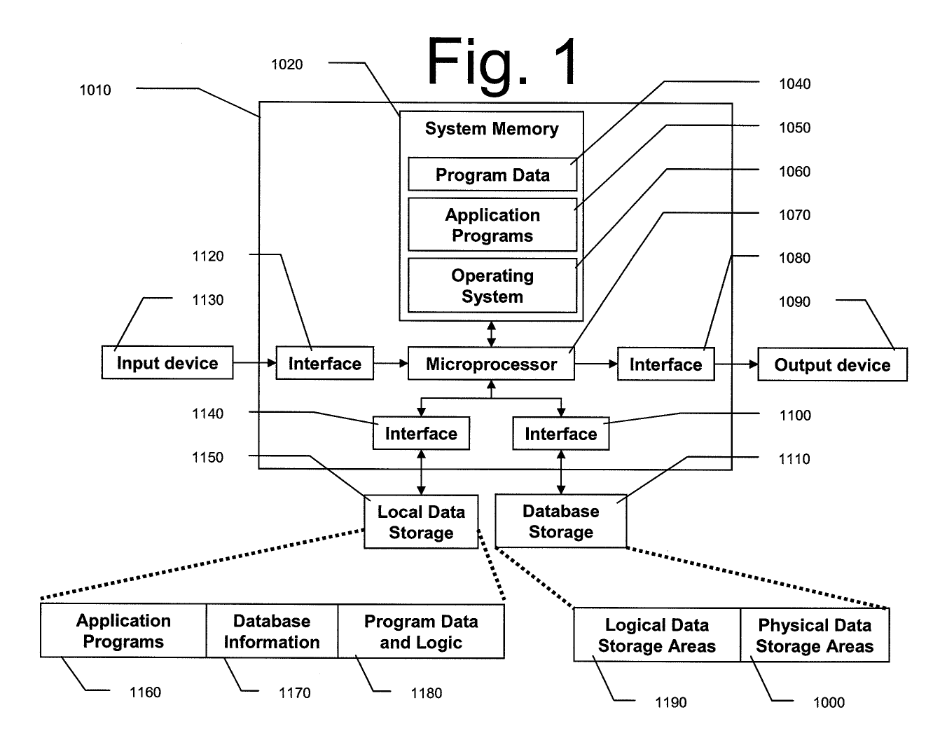

Aspects of the present invention are related to systems and methods for deploying and managing a collaborative instructional delivery environment. A block diagram of a computer system configured to operate as all or part of such a system is depicted in FIG. 1. In the overall system 1010, a system memory area 1020 such as RAM, flash memory, or other volatile or non-volatile storage media, may contain program data 1040, which includes data related to curriculum and course management/access. The system memory may also contain application programs 1060, which includes the one or more application programs associated with the collaborative instructional delivery system. The memory may also include an operating system 1070 which may be one of several commercially available operating systems or may be a customized operating system included as part of or otherwise tied to the collaborative instructional delivery system and application(s).

A microprocessor 1070 interacts with the system memory and also with the several interfaces 1120, 1080, 1140, 1100 to one or more input devices 1130, output devices 1090, local data storage 1150, and any associated database storage 1110 beyond or inclusive of the local storage. Some variations of input 1130 and output 1090 devices may include displays, storage media, network interfaces and/or other data exchange devices and capabilities for communicating information to client and/or server devices, databases, other content repositories, and/or the data exchange and communication systems associated therewith.

The local data storage 1150 may include storage portions related to application programs 1160, database information 1170, and program data and logic 1180. Local data storage may also include removable storage media such as volatile and non-volatile memory media including magnetic discs, tapes, memory chips, optical discs, punch cards, and/or chemical/biological storage media.

Database storage 1110 may include information identifying logical data storage areas 1190 such as tables, indices, keys, stored procedures, triggers, and queries and physical data storage areas 1000 that relate to the actual locations on hard drives or other storage devices where information is stored. This may include information about things such as RAID (redundant array of independent discs) striping and other data required to identify which particular storage locations contain what information.

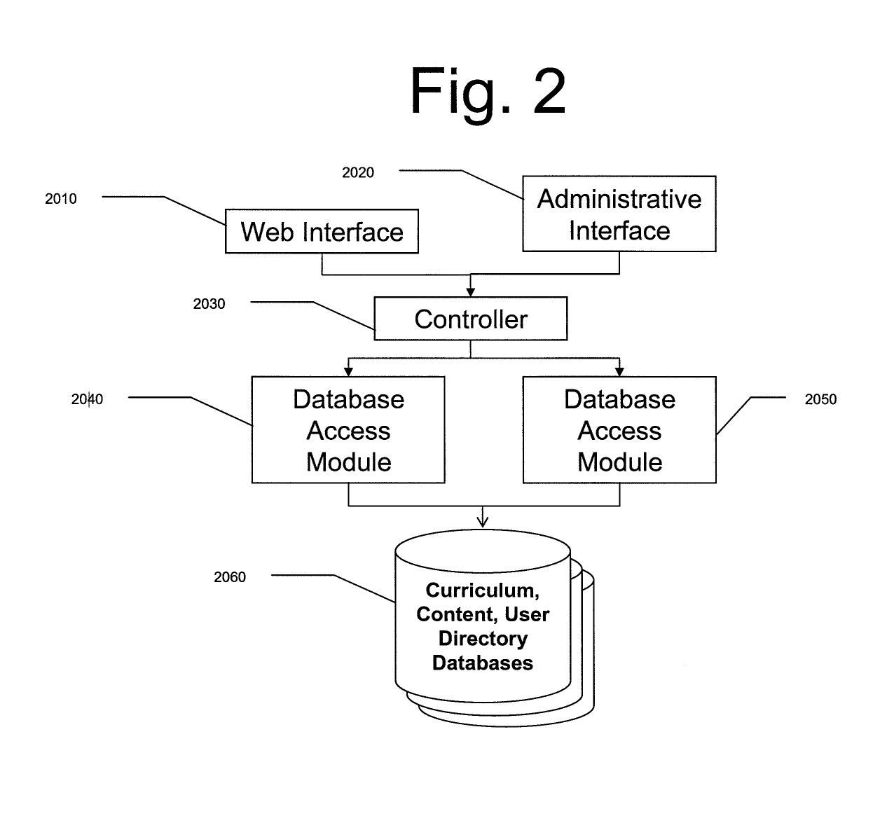

The system of FIG. 1 may be part of all of an overall system as depicted in FIG. 2. In the system shown in FIG. 2, a web interface 2010 is the primary end-user interaction method with the overall system. In some variations, the web interface may be replaced with an application front end that is part of a software package, a thin client application, a customized browser, or some other form of interactive data viewing and manipulation.

Administrators and system maintenance personnel may use a separate administrative interface 2020 that may be either a web-based system, a thin client, a custom application, or some other form of interactive data viewing and manipulation. Both interfaces may interact with one or more controllers 2030 that manage database access modules 2040 based on defined user roles and privileges that determine appropriate levels of access for particular users and/or user types. The interfaces may interact with a controller directly or via one or more networks and/or intermediate servers or applications. A controller 2030 may also in turn interact directly with a database or may communicate with one or more intermediate servers and/or applications via one or more public or private network or dedicated data exchange pathway to a database server. The database access modules enable a controller to facilitate communication between the interfaces and databases 2070 containing course, curriculum, schedule, other academic planning information, and information resources, instructional and professional development, related to specific subject or content areas and information about how they relate to courses and/or curricula.

The content in the database 2060 relates to curriculum based on associations between information resources, courses, thinking and academic success skills, essential questions, subject areas and/or standards and indicators within a particular content area.

In some variations, each interface may have its own associated controller. In other variations, there may be distinct interfaces for educators, students, education administrators, and system administrators. In yet further variations, there may be one common interface, with features and access levels determined by user type. User types in such a variation may include educators, admin-level users, content authors, administrative personnel, and any other suitable or necessary types.

In some variations, the database access modules may be combined into a common database access module overlaid on either a common database or on an integrated suite of databases. In further variations, a single physical storage location may be separated into multiple logical database structures, each with a distinct access module and/or access module portion. In yet further variations, physically distinct storage locations may be grouped into a logical database having a common access module.

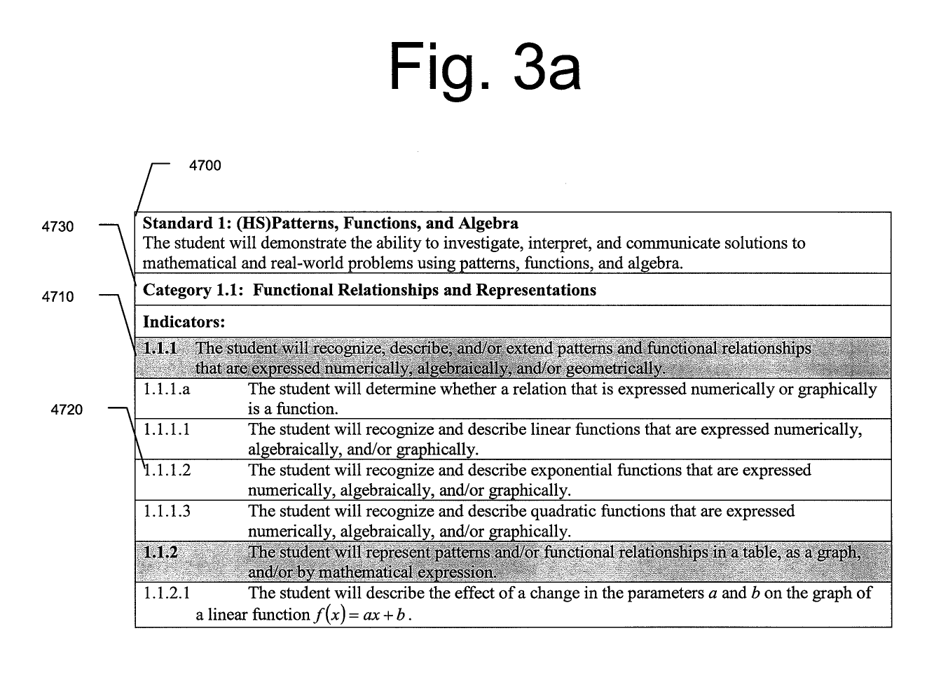

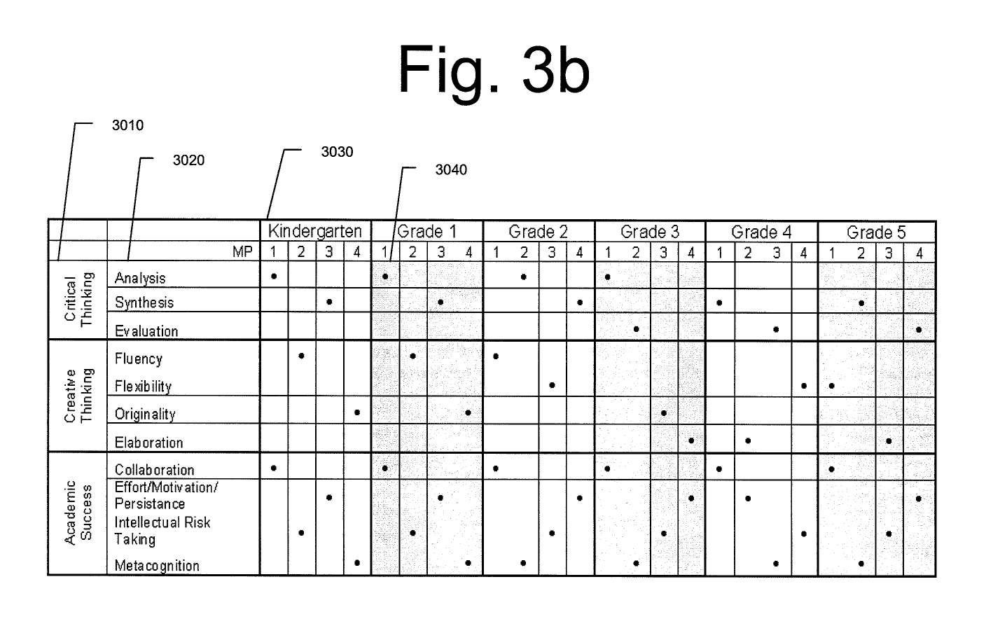

Standards and indicators are specific portions or defined areas of knowledge or ability identified within a course or content area. An example of standards and indicators for Algebra is shown in FIG. 3a. Standards and indicators may be grouped by a standard 4700 which itself has categories 4730, and indicators within each category 4710. The indicators themselves may be further sub-divided into specific sub-section 4720 depending on the particular importance of certain learning concepts and a desired granularity of measurement. Standards and indicators, which can be used to set and measure the pace and progress of instruction, can themselves be associated, via courses, with thinking and academic success skills (TASS). These TASS are related to broad conceptual areas of learning and understanding across content areas. These TASS are associated with an academic schedule that determines which standards and indicators should be focused on at which time during the pace and progress of a course. An example of the association between TASS and an academic schedule is shown in FIG. 3b

In FIG. 3b, each set of success skills is grouped into a broad focus area 3010 such as Critical Thinking. This may include things such as evaluation and analysis skills 3020. For each grade level 3030, the TASS in this schedule are broken out by academic quarter 3040. In this case, for Grade 1, Analysis skills are emphasized in the first quarter of the academic year. In other variations, TASS may be grouped by course and directly tied to standards and indicators identified for focus on a per-unit, weekly, or even daily basis within a particular course lesson or lesson unit. Standards and indicators are created and managed on a per-content-area basis (i.e. math, reading, etc) and sometimes on a per-course basis (i.e. calculus, essay writing).

The variation shown in FIG. 3b is for kindergarten and elementary instruction. Variations of TASS, and their associated mapping, may be more complex in higher level instruction where there are more specific subject areas of focus. In such variations, the focus areas 3010 may be further aggregated within an overall subject area, such as science, or within an overall course, such as geometry.

In the variation shown, the aggregated TASS 3010 are interdisciplinary. In some variations directed to specific subject areas, TASS may be duplicated between subjects to ensure that each skill is connected to an indicator focused on a particular learning area within a subject area. For instance, analysis 3020 may be associated with indicators for science as well as for mathematics. In some variations, both science and mathematics would have distinct indicators associated with the skill area of analysis. This would allow the indication and association of math resources for analysis without causing confusion with science content for analysis. In cases where instructors look for subject-specific materials based on a particular success skill, this prevents them from being overwhelmed with irrelevant information.

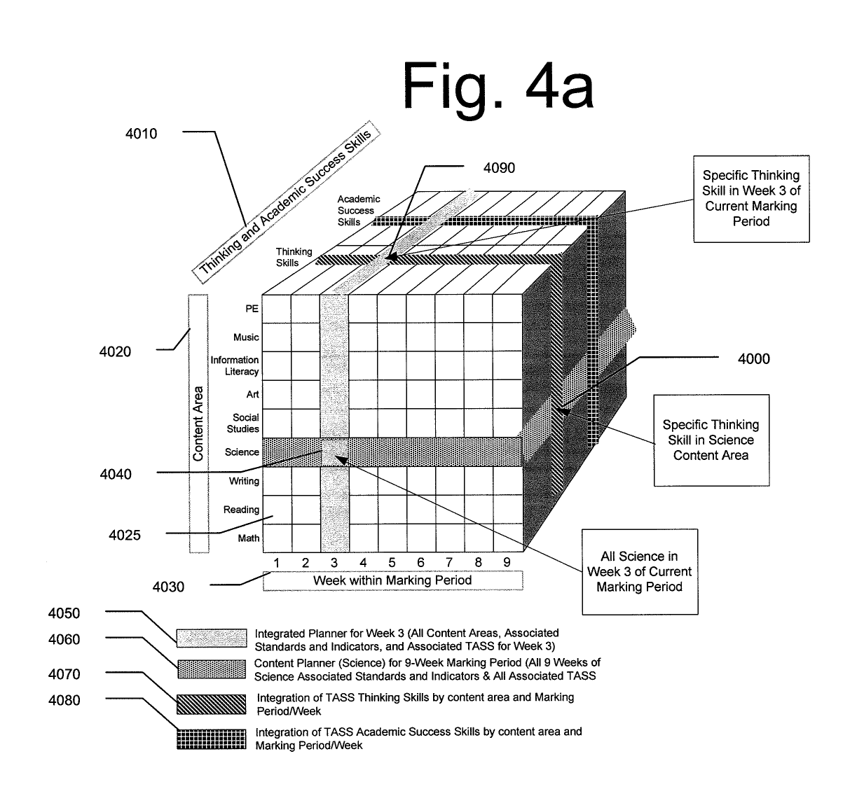

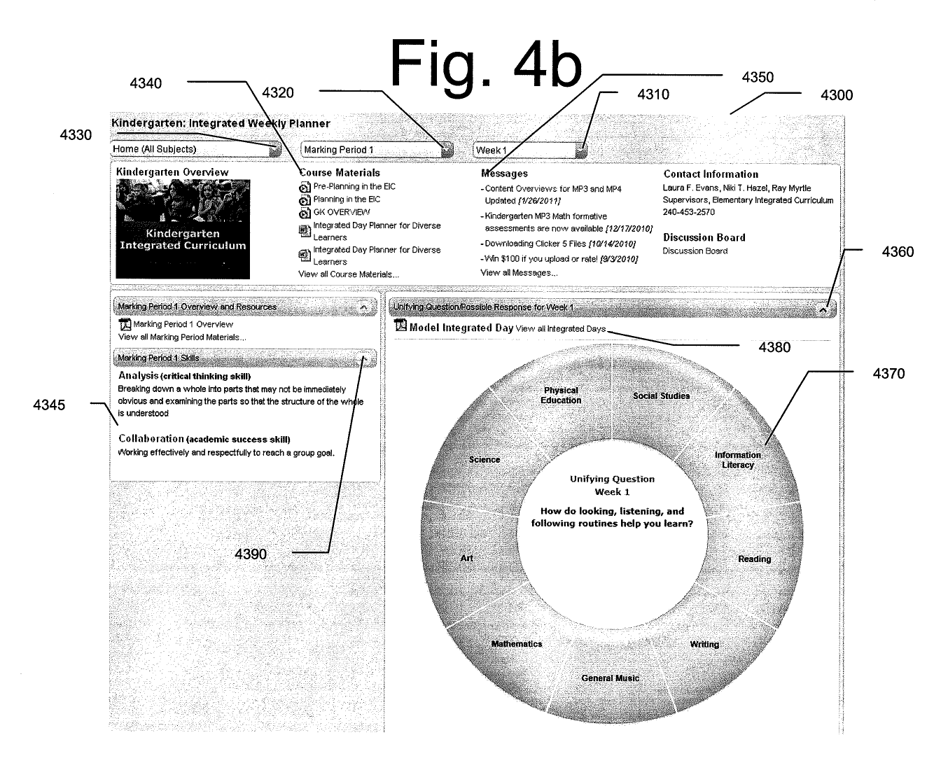

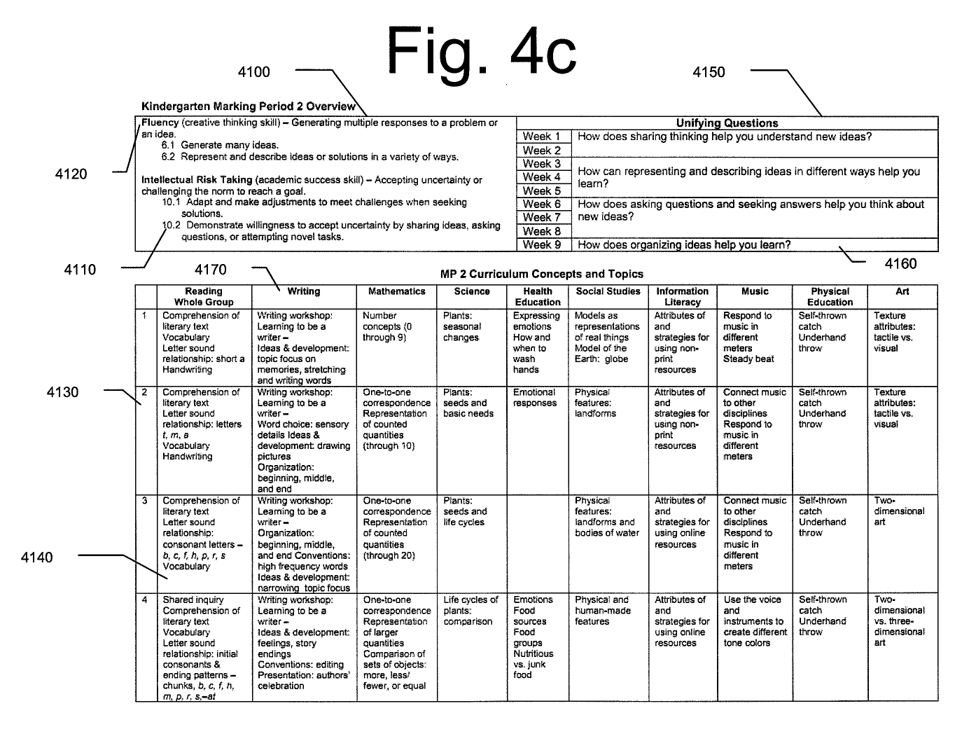

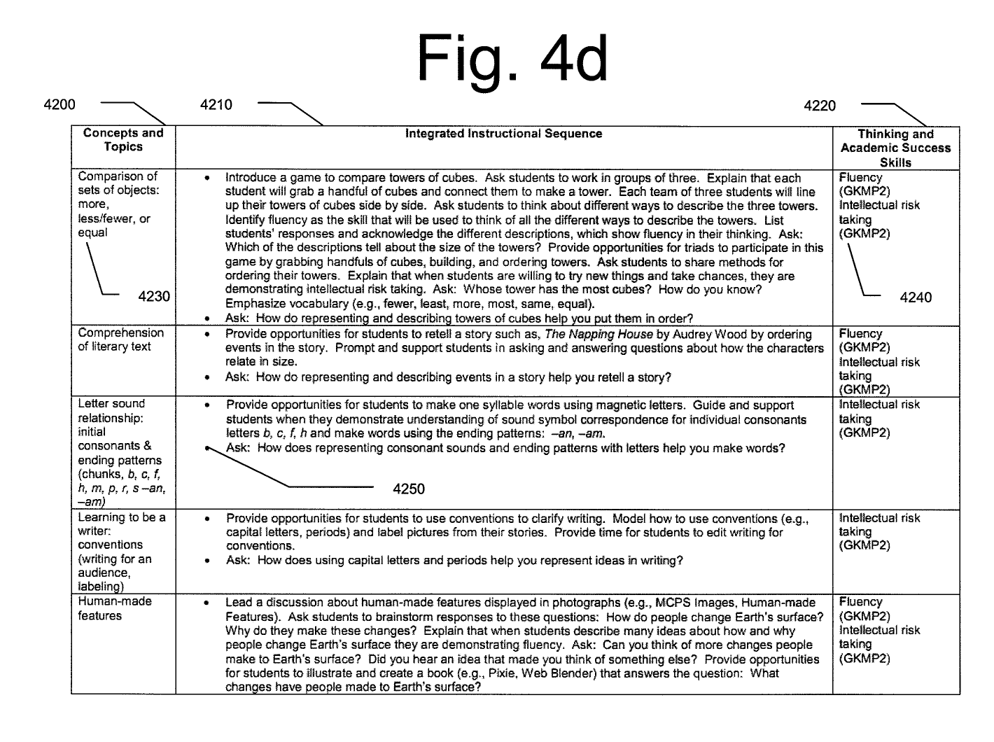

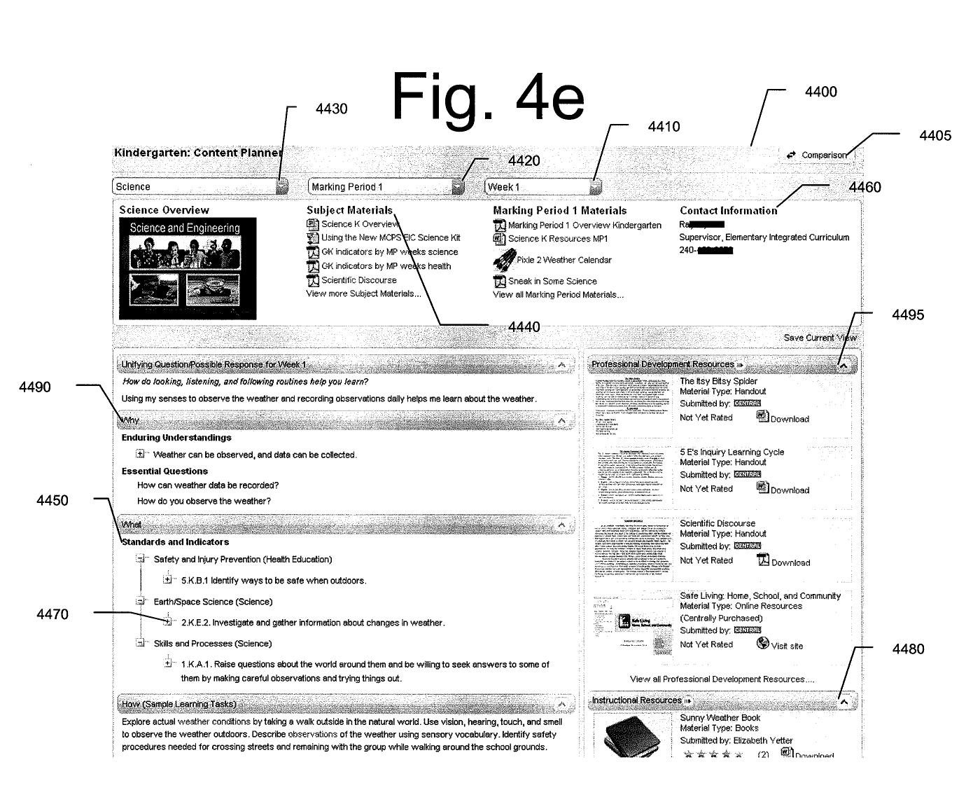

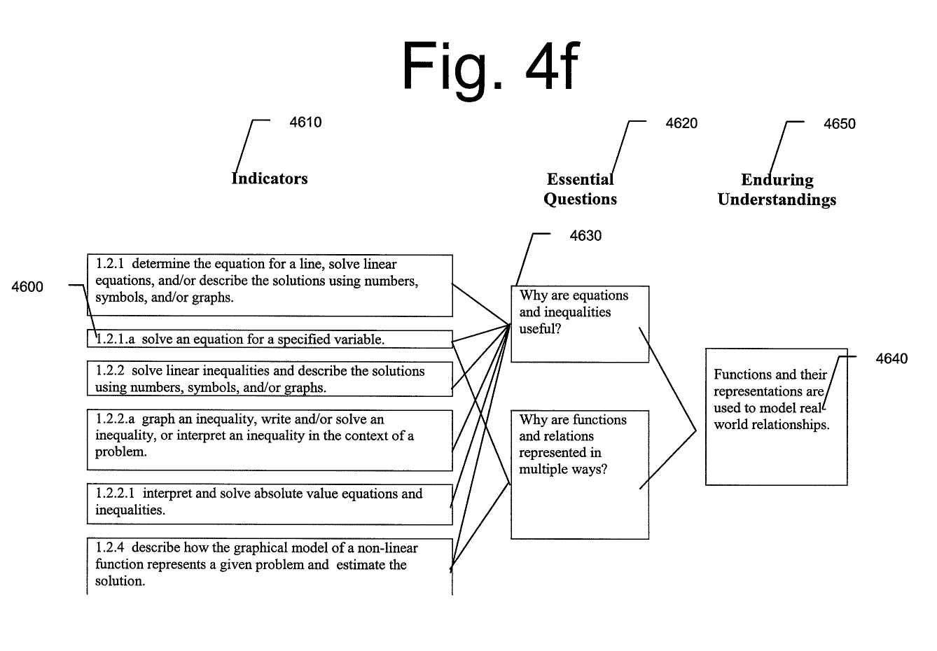

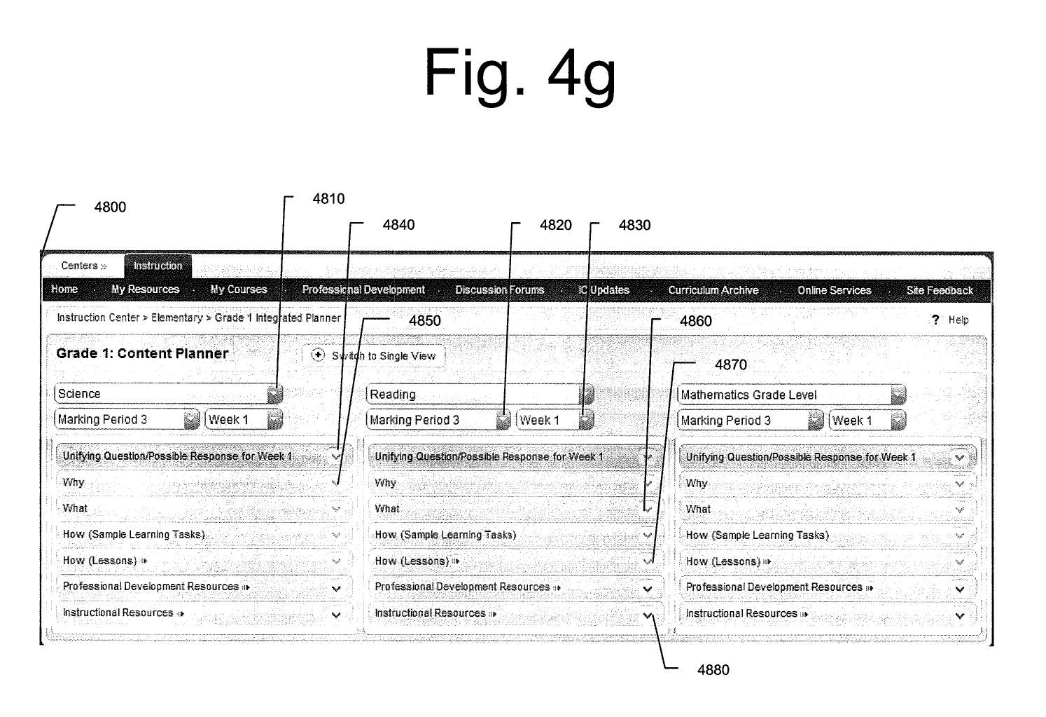

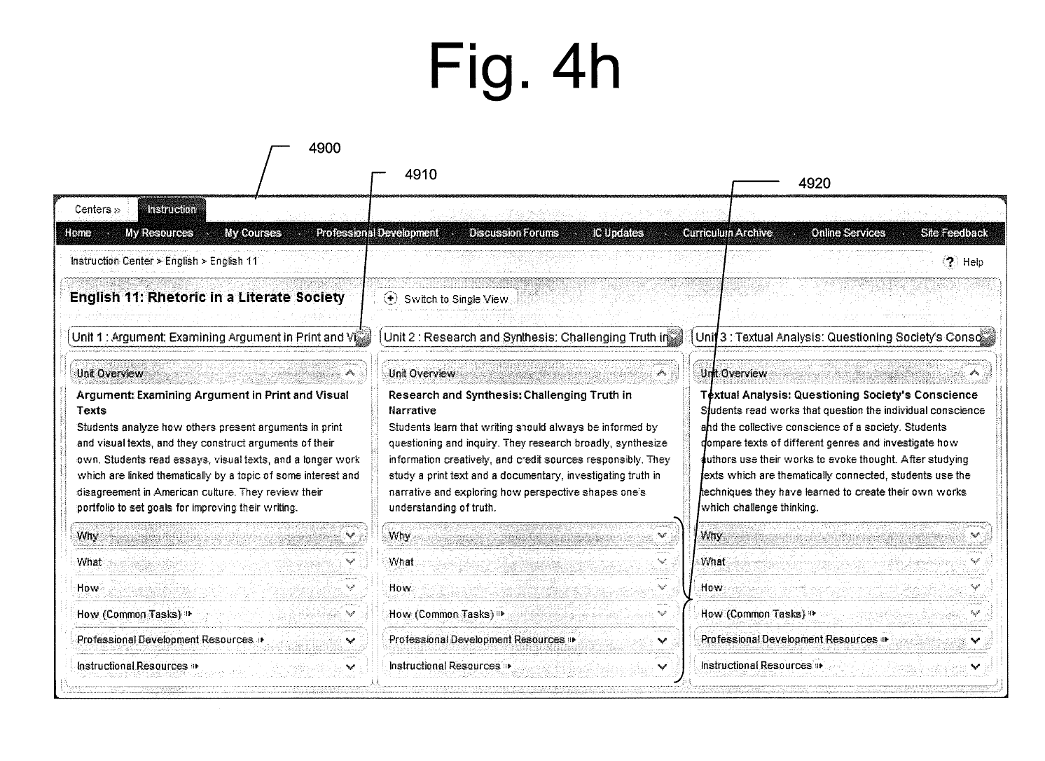

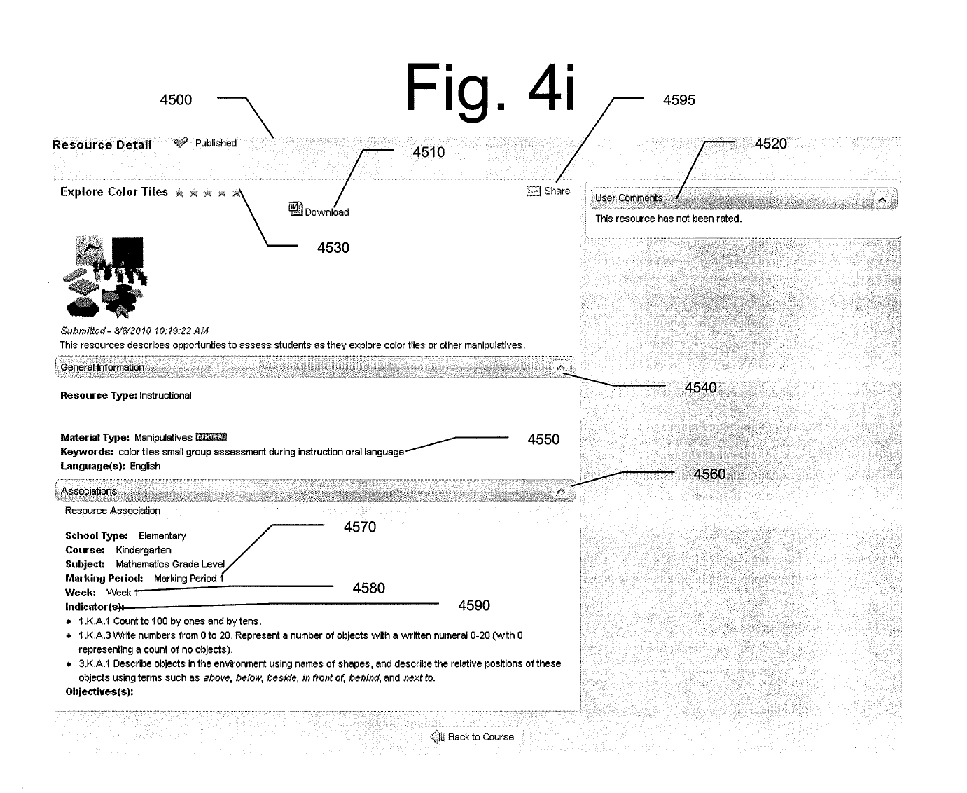

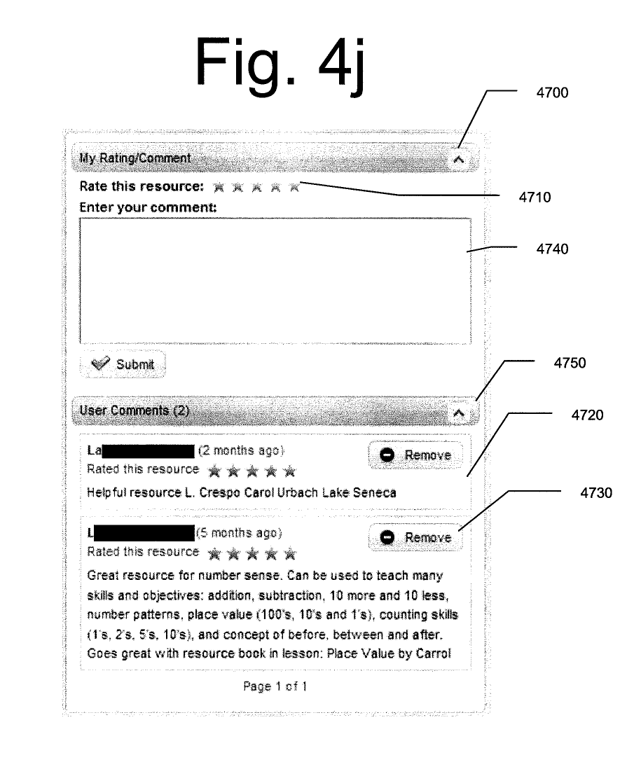

In some variations of a system as discussed herein, the relationship between standards and indicators, courses and/or subject areas, and the academic schedule may be envisioned as a 3-dimensional array where each cube in the array represents a particular intersection of a subject area, an indicator, and a particular point in time. An embodiment of such an array is shown in FIG. 4a.

FIG. 4a shows the interaction between focus areas of TASS 4010, content areas (or courses) 4020 and the academic schedule 4030 to create lesson unit areas for an integrated, multi-subject course. In the embodiment shown, a particular skill set, such as thinking skills, may be seen as one side of a 3-dimensional array. The surfaces of the array indicate associations between any two areas—skill sets and schedule 4090, content area and skill set 4000, and skill set and schedule 4040.

In FIG. 4a, the interaction between content areas 4020 and academic success skills 4010 within a given schedule period corresponds to the integrated planner 4050 aspect of the system. The integrated planner 4050 is a cross-content curriculum meant to provide comprehensive elementary education strategies for the development of fundamental skill sets. It relates to all content areas (and associated standards and indicators) and associated TASS for a given time period and/or schedule unit. Such a tool is preferable in an integrated, multi-subject course because one teacher typically teaches two or more subjects to the same group of students. This allows for interdisciplinary synergies to be realized in the classroom much more effectively.

Such an integrated planner 4050 may interact with a content planner 4060 that enables a teacher to plan a series of lessons within a content area based on the focused-on academic success skills throughout the schedule units of the marking period. Such a content planner 4060 relates to all the TASS and all the related time periods and/or schedule units for a given content area (and its associated standards and indicators). This type of content planner 4060 may be associated with mappings 4070, 4080 of individual academic success skills across all content areas. These mappings help identify resources appropriate for a particular area of instruction within a content area for a particular schedule unit. These mappings also define the interaction between TASS 4010 and a particular content area 4025. Since each content area is associated with one or more standards and indicators, the mapping also defines the relationship between TASS and standards and indicators.

In single-subject course variations, the integrated planner 4050 may be replaced by a subject-area-specific or course-specific planner that an individual teacher could use for their particular course. The content planner aspect may be relatively unchanged, with the mappings between resources and success skills being driven by standards and indicators from a particular content area or course.

In both an integrated and a subject-specific approach, the intersection of a success skill 4010, a course or subject area 4020, and a schedule unit within an academic timeframe 4030 combine to identify a single area “within” the cube that defines an association between the skill set, the schedule, and the content area 4040. At this nexus, an instructional plan with an associated set of resources may be identified as addressing a skill set related to specific standards and indicators within a content area at a given point in the academic schedule.

An embodiment of an integrated planner 4050 tool is depicted in FIG. 4b. In the embodiment shown, the tool is a web-based interface 4300. The embodiment shown is for a kindergarten course, but other embodiments may be suitable for a range of cross-subject and/or interdisciplinary courses (such as, for instance, an equipment cross-training course in a military, factory, or vocational setting).

In the interface shown 4300, a user may select a particular subject 4330, time period 4320, and sub-period within the time period 4310. The embodiment shown is set to view the integrated, cross-subject aspect 4330 of the first week 4310 of the first marking period 4320. Alternate embodiments may be configured for years and months, trimesters and days, semesters and weeks, or any other suitable combination thereof. Yet further embodiments may have a third or even a fourth or fifth level of temporal granularity, allowing for a view by year, by month, by week, by day, and by hour. Other embodiments may have only a single level of temporal granularity, with a view only by marking period or month or week.

The course materials 4340 relevant to the course and time period selected are displayed so as to be accessible to the user, along with any relevant messages 4350 from administrators or related to course or content delivery. TASS 4345 relevant to the marking period 4390 are identified and listed next to an overall view of an integrated subject planner 4360. Each subject 4370 may be selected to access a content planner specific to that subject, and an integrated, cross-subject lesson plan for a particular day 4380 is also available via the interface. Hovering over each subject 4370 results in a “pop-up” hint that provides the appropriate answer to the unifying question for that subject and sub-period (week in this embodiment.)

FIG. 4c shows an integrated instructional plan as a database divided on axes of time (sub-period) 4130 and subjects 4170, with the TASS 4120, 4110 relevant to the overall marking period (time period) in question 4150. The unifying questions 4160 are a tool to help teachers focus instruction across all subjects onto the TASS indicators. Each particular subject or content area 4170 has certain areas of instruction 4140 identified and selected for each sub-period based on the TASS 4120, 4110 and associated unifying question(s) 4160.

FIG. 4d shows an integrated instruction sequence, with topics 4200 based on standards and indicators, associated instruction 4210, and the relevant success skills 4220 covered by the instruction and related to the topic. Each indicator-based topic area 4230 is related to a particular content area and the instruction portion may include suggested content delivery as well as suggested questions/interactions 4250 to test and reinforce information retention. Instruction in content areas may be associated with one or more particular TASS 4240 for a given marking period, week, day, or other relevant time period.

FIG. 4e shows a screen shot of an embodiment of a content planner tool 4400. The tool shown in this embodiment is web-based, but alternate embodiments may use customized applications or off-the-shelf software to create various interfaces and data processing capabilities. Similar to the integrated planner tool, a user may select a particular subject 4430, a time period 4420, and a sub-period within that time period 4410. Subject materials relevant to that particular subject 4440 are provided for easy access, and any relevant contact information for course/subject management or administration is also provided 4460.

In the content planner 4400, the standards and indicators 4450 depicted are those particular to that subject or content area. In the embodiment shown, a collapsible view is provided showing particular objectives 4470 under broader indicator categories. Another collapsible view shows enduring understandings and essential questions 4490 associated with the subject or content area. These essential questions and enduring understandings 4490 are associated with the standards and indicators 4450 to provide a measurable and clear connection between the content and purpose of instruction in a course.

FIG. 4f shows an embodiment of a chart demonstrating connections between standards and indicators 4610, essential questions 4620, and enduring understandings 4650. A particular indicator 4600, which represents the “what” of instruction—that is, the substance—may be associated with multiple essential questions 4620. A particular essential question 4630, which represents the lower-level “why” of instruction—that is, a specific rationale for teaching a particular concept—may be associated with multiple indicators 4610. Essential questions 4620 may also be aggregated into enduring understandings 4650 in a many-to-many relationship. An enduring understanding 4640 is a higher-level “why” of instruction—a broader rationale for undertaking to learn a content area or portion thereof.

The embodiment shown in FIG. 4e also has a comparison feature 4405 that enables comparison and review of content plans across subjects 4430, marking periods [time periods] 4420 and sub-periods 4410. An embodiment of such a comparison is shown in FIG. 4f.

FIG. 4g shows a comparison view 4800 across subjects 4810 for either a different or same marking period 4820 and sub-period 4830. Other variations allow for comparison of any combination of disparate and/or common subjects, marking periods, and/or sub periods. The embodiment shown allows for comparisons of relevant unifying question(s) 4840, TASS 4850, standards and indicators 4860, specific portions of instruction and/or lessons 4870, instructional resources 4880, and any other relevant portions of instructional information managed and maintained by an embodiment of a collaborative instruction delivery and management system as described herein.

Variations related to individual subjects and/or content areas may also include comparison views as shown in FIG. 4h. In the embodiment shown, the comparison view 4900 relates to a specific course (e.g., English 11) within a content area. Comparison in the embodiment shown may only be made across time periods of instructional units 4910 within the course. In other variations, where a subject or content area may cross multiple marking periods, comparison may be made across marking periods and period sub-units. As in the embodiment shown in FIG. 4g, comparison may be made of any and all education planning, delivery, and instructional resource aspects maintained and tracked by the system 4920.

Also, as shown in FIG. 4e, instructional resources associated to that course/subject/time period are appropriately embedded in a dedicated area of the screen 4480. Each resource may be identified with user ratings to indicate other teachers' opinions of that resource and thereby enable a teacher to decide if they wish to use it as well. In some embodiments, a content planner 4400 may not be associated with an integrated planner. This may be suitable for courses that are single-subject focused and not tied to an integrated course of study. In such variations, the subject selector 4430 may be omitted or replaced to allow selection of those subjects a particular teacher is teaching regardless of grade level or within a grade level.

FIG. 4i shows a screen shot of an embodiment of a resource management tool 4500. The tool shown in this embodiment is web-based, but alternate embodiments may use customized applications or off-the-shelf software to create various interfaces and data processing capabilities. Users may view an average star rating 4530 for a particular resource resulting from individual user ratings 4520, download it in the applicable file format 4510, post and/or read comments from other users 4520, and view the general information 4540 and associations 4560 of the resource. The general information 4540 includes keywords for locating the resource via a search. The associations 4560 include time- or schedule-based associations 4570, 4580. In the embodiment shown, a resource is associated with one or more weeks in one or more marking periods. Other embodiments may vary the schedule based associations according to schedule granularity as discussed above. A resource can also be associated with one or more indicators 4590 that identify the particular skill(s) that resource is meant to teach, develop, or reinforce. Grade level, subject, language, and material type are other pieces of information that may be provided in either a general information 4540 or association 4560 field of a resource.

Also depicted in FIG. 4e are professional development resources 4495. These are resources for educators/teachers to use in developing an instructional plan and also in honing and improving their skills and techniques in terms of education delivery. Professional development resources 4495 are stored and handled like any other educational/instructional resource but are intended for the teacher presenting a course as opposed to for use during instruction. Such resources may also be up-loaded, associated, and evaluated and rated by teachers/users.

FIG. 4j shows an embodiment of a rating/comments utility 4700 that may be displayed in a user comments area 4520 in a resource management tool of the type shown in FIG. 4i. The user input section of the utility may be equipped with a rating scale tool such as a star rating 4710 where a user may give a resource a rating of between 1 and 5 stars. Other variations may use more or fewer stars or a different rating scale altogether, such as a number scale or some other representational rating scheme (smileys, pencils, thumbs-up, positive and negative numbers, etc.). In some variations, the rating scale portion 4710 may be omitted entirely, leaving only a user comments area 4740 where a user may write a review or add other comments about the resource in question and/or their impressions thereof. In other embodiments, the user comments area 4740 may be omitted and only a rating scale portion may be available to a user.

In further variations, a prior comments area 4750 may show previous comments 4720 posted by other users. Such comments may include a rating, written commentary, a posting date/time, and/or a user's name and contact information. In some variations the user comments area may have an administrator or moderator level view that allows one or more administrative or moderator type users to review comments for appropriateness and relevance and remove 4730 those comments deemed improper or irrelevant.

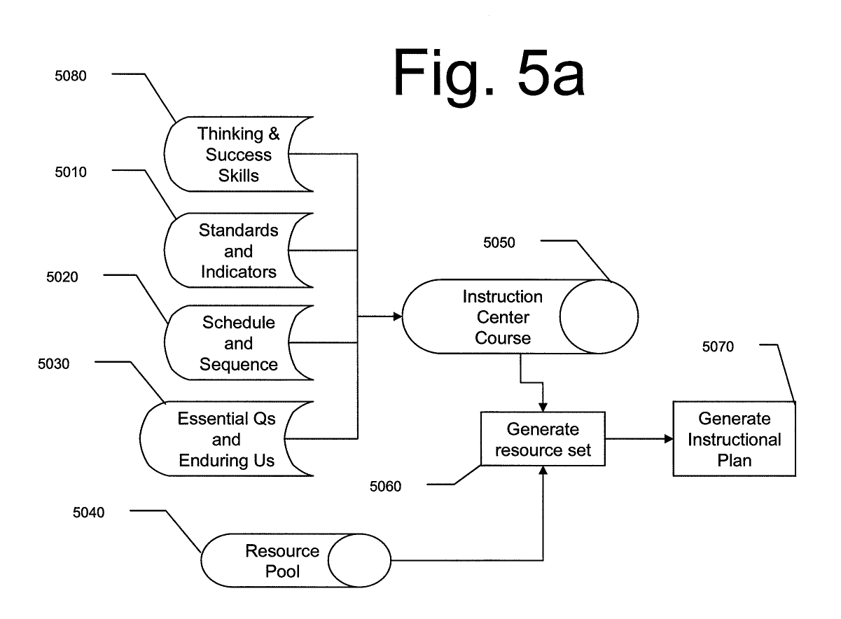

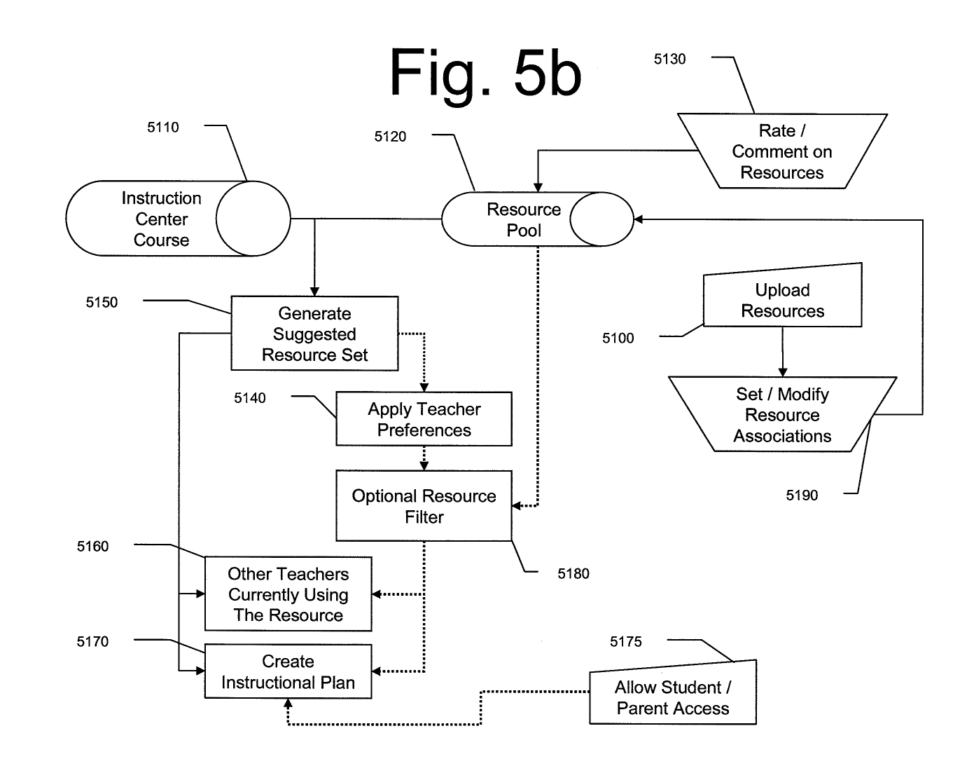

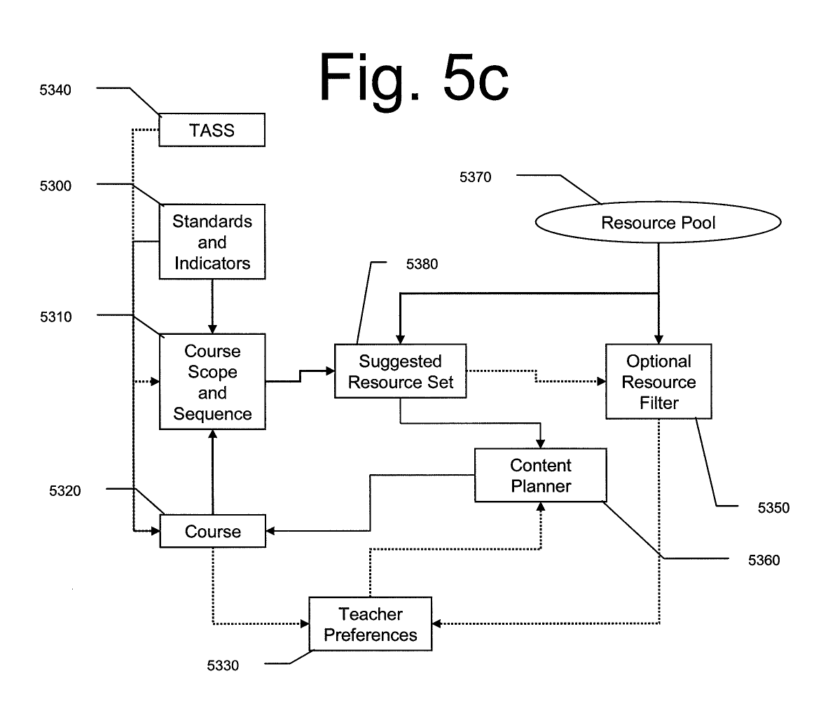

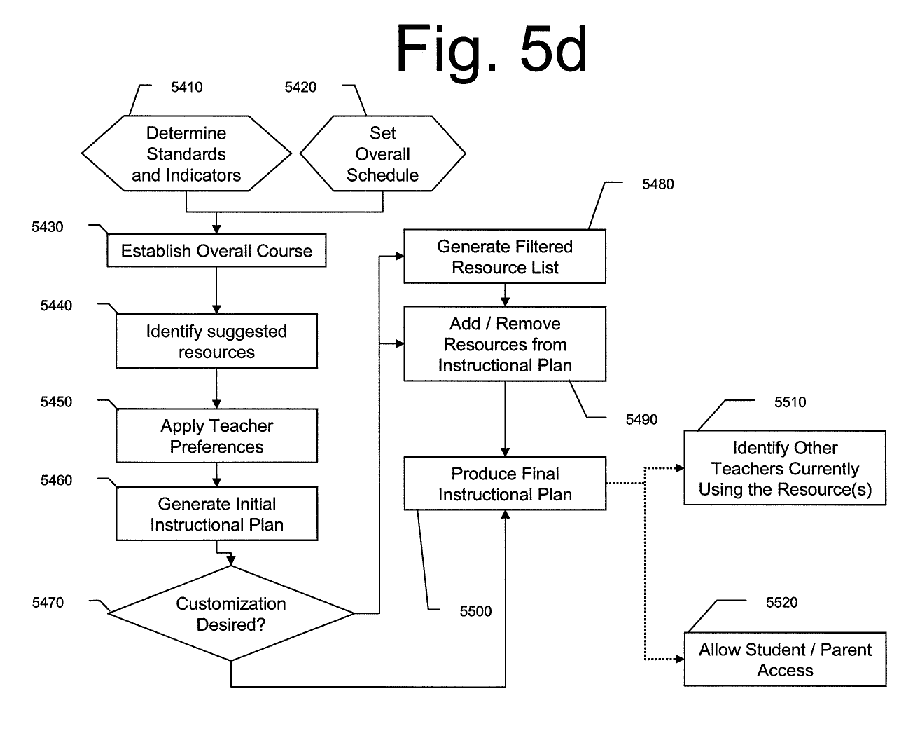

A possible structure and general operation of a variation of a system configured to create, manage, and deliver the lesson and content planning and association capabilities discussed and described in FIG. 4 is shown in FIGS. 5a-5d.

FIG. 5a is a high-level block diagram showing the overall data sources and the general operating principles of an integrated academic planning system. In the system shown, standards and indicators (defined by content area) 5010, thinking and academic success skills 5080, an academic schedule and associated sequence 5020 (which may include one or more specified levels of granularity, such as week, month, semester, etc.), and, in some cases, a set of essential questions and enduring understandings 5030 combine to create an instruction center course 5050. In integrated, cross-subject embodiments such as those sometimes used in K-5 education, the course 5050 is a multi-subject framework meant to address a set of academic success skills on a per-schedule-unit basis by connecting them to content-area standards and indicators through an appropriate essential question. This may be seen, in some variations, as a set of integrated planners 4050 delivered over the course of the academic schedule.

In some subject-specific embodiments, the unifying question(s) may be omitted because content-area-specific standards and indicators 5010 may already be mapped or related to particular TASS. In other embodiments, partial integration may be enabled through established relationships between certain courses or certain content areas, such as art and geometry or history and literature. In such embodiments, a unifying question connecting the two or more content areas may be appropriate.

When an instruction center course 5050 is created, a suggested or default resource set may be associated with it 5060. The suggested resource set represents those portions of instruction and lessons suggested as useful for teaching students a demonstrable understanding of the subject(s) in question. This may include material specific to grade-level standardized testing. In some variations, a default resource set may be supplemented or modified, in whole or in part, with resources preferred by a particular teacher based on how they teach that particular course to a particular class.

Once a resource set is in place 5060, one or more specific instructional plans may be generated 5070 for one or more particular schedule units within the academic calendar of the course. Such an instructional plan 5070 may draw resources from a resource pool 5040 to create a customized or teacher-preferred learning experience for some or all of the students in that teacher's class. In variations configured for differentiated instruction, a teacher may identify and select resources targeted not only for a particular class learning a particular subject or subjects, but also for particular students within the class that may have specialized learning needs.

FIG. 5b describes a variation of course creation and instructional plan generation in more detail. An instruction center course 5110 may be associated with certain resources from the resource pool 5120 to generate a suggested resource set 5150 that includes the recommended/suggested content and lessons/lesson types for a given course through the academic calendar. This suggested resource set 5010 may then be modified through a set of teacher preferences 5140. Such preferences may indicate a desire for more multi-media content, such as videos and interactive learning exercises, or may give stronger preference to certain resource parameters (i.e. using all the same resources as those of another teacher, or using resources uploaded/authored by certain people). In some variations, teacher preferences 5140 may include a preference for an instructional plan with no pre-populated resources. In other variations, teacher preferences may include particular favorite resources and/or interdisciplinary resources based on a known or expected instruction schedule in a related course (such as the overlap between calculus and physics, for instance).

After teacher preferences (if any) are applied 5140, a specific instructional plan 5170 or set of instructional plans may be generated for a course for one or more schedule units in the academic calendar. Also, based on the resources included in the instructional plan(s) 5170, other teachers either currently using or experienced with using the same resource may be identified 5160 as sources of advice, guidance, and collaboration. In some variations, an instructional plan may be generated directly from the suggested resource set without a teacher preference 5140 step.

In some variations, teacher preferences 5140 may be replaced or augmented with optional and/or automated resource search and filtering capabilities 5180. A resource filter 5180 may be applied based on either user-provided or previously-stored filtering criteria. Such criteria may include a media type (audio, video, interactive, print, online, etc.), a language (English, Spanish, Chinese, etc.), a publication date, an upload date, an author, association with one or more standards and indicators, keywords describing the resource, and any other suitable search and/or filter criteria. Based on the filter criteria provided, the resource filter may produce a list of resources from the resource pool 5120 that meet those filter criteria. A teacher may then designate one or more of those returned resources for inclusion in the specific instructional plan(s) 5170 and also find out if other teachers are using or have used this resource 5160.

After a specific instructional plan is generated 5170, some embodiments may enable or allow access to the instructional plan by a student and/or a parent 5175. Such access may be web-based or provided through a customized application or interface. A student or parent may use the accessed information to acquire copies of resources and track their personal progress through a course. In some variations, allowing for parent/student access 5175 may enable a student or parent to develop an individualized learning plan. In some cases, students and parents may also interact directly with a teacher through a variation of the instructional plan 5170.

In addition to searching for resources in the resource pool 5120, teachers may also add resources 5100 to the pool 5120. In some variations, a teacher may upload a lesson resource 5100 to the resource pool 5120 via a web interface or a customized application front end or by e-mail submission or some other way. In a web or application based variation, the uploaded resource may be designated as public or private. A private resource will be visible only to the uploading teacher, whereas a public resource will be visible to all educators using/accessing the pool 5120.

Either as part of the upload process, or immediately after upload, a resource may be associated with one or more courses, content areas, standards and indicators and/or academic success skills 5190. This allows each resource in the pool 5120 to be tied to a specific learning objective, course or subject area. Such an approach makes the identification, sharing, and development of learning resources more efficient and more effective, and also allows for better collaboration between teachers. In some variations, already uploaded resources may also be associated or re-associated with TASS, content areas, courses, and/or standards and indicators. A teacher may identify opportunities for inter-disciplinary or synergistic use of a learning resource with respect to a subject area or an indicator not currently associated with the resource. In such instances, a teacher may create a new association or set of associations for the learning resource. These associations may be public or private also, such that they may be visible only to the creating teacher or available as a search/filter criteria to all other teachers interacting with the resource pool 5120. Furthermore, teachers interacting with the resource pool 5120 may provide feedback and comments on the lesson resources therein 5130. Ratings and comments may include opinions on the suitability of resources for particular subject areas and/or indicators, suggestions for expanding or narrowing keywords, descriptions, and indicator associations for a lesson resource, and/or tips on use and incorporation into a teaching strategy and/or classroom setting. Ratings and comments may be visible to all teachers when viewing the resource. In some variations, the rating and comment feature may be moderated such that comments and ratings are evaluated by an administrator before being made visible or monitored/acted upon after being made visible.

FIG. 5c shows a more detailed embodiment of a system structure for a web-based or application-based academic planning and instruction management solution as discussed herein. In the system depicted, standards and indicators 5300 and TASS 5340 define the structure of a course 5320. The course 5320 (which may be either a multi-subject integrated course or a content-area-specific course) and its associated TASS 5340 and standards and indicators 5300 combine over the course of an academic schedule to define the scope and sequence of the course 5310. This scope and sequence 5310 may be regarded as a course framework into which a suggested resource set 5380 may be introduced. The suggested resource set is a set of default and/or suggested lesson content drawn from the resource pool 5370 to populate a course framework 5310 with teaching materials appropriate for each schedule unit (day, week, month, semester, etc.) of the course.

In some variations, this suggested resource set 5380 may be accessed by a teacher via a content planner tool 5360. The content planner enables a teacher to view and access resources for a particular schedule unit and identify the connection between a resource and its associated TASS and standards and indicators. Such a content planner may be web-based or may be a particular computer application or a portion thereof. The content planner 5360 enables a teacher to arrange and combine the resource set 5380 into a particular instructional plan for an instance of the course 5320 being taught by that teacher. In some variations, arrangement and combination process may be augmented or guided by teacher preferences 5330 that are directly input, actively solicited, or previously stored in the system. Such preferences may indicate an interest in more multimedia materials, a greater range of interactive teaching tools, preferences for particular languages, certain publishers or authors, resource ratings, and any other criteria tracked by the system with respect to resources. Such teacher preferences 5330 may also be varied on a course-by-course basis.

In some variations, the suggested resource set may be further customized with an optional resource filter 5350. In some variations, the resource filter 5350 may also inform and/or be driven by teacher preferences 5330. The resource filter may be applied based on either user-provided or previously-stored filtering criteria—some or all of which may, in some variations, be included in the teacher preferences 5330. Such criteria may include a media type (audio, video, interactive, print, online, etc.), a language (English, Spanish, Chinese, etc.), a publication date, an upload date, an author, association with one or more standards and indicators, keywords describing the resource, and any other suitable search and/or filter criteria. Based on the filter criteria provided, the resource filter may produce a list of resources from the resource pool 5370 that meet those filter criteria. A teacher may then designate one or more of those returned resources for inclusion in an instructional plan via the content planner tool 5360 or a search results tool that works in conjunction with the content planner.

An embodiment of an overall sequence of use and operation, from the standpoint of course creation and teacher generation of lesson plans, for systems of the type depicted in FIGS. 5a-5c, is shown in FIG. 5d. In the embodiment shown, standards and indicators are determined 5410 and an academic schedule is set 5420 ahead of time. Such information is provided to the system to enable its operation and use. An overall course may then be established 5430 based on standards and indicators and their connection/association with schedule units in the academic calendar. In integrated embodiments, the overall course covers the standards and indicators identified for a grade level for an academic period. Such a course may cover multiple subject areas and may address academic success indicators not specifically tied to a particular subject area. In non-integrated embodiments, the overall course is tied to a particular subject area and only covers standards and indicators specific to that subject area.

Once an overall course 5440 is in place, suggested resources 5440 may be added to the course. Such content may be based on established learning requirements, system defaults, or an accepted model learning resource set for lesson plans. The suggested resources may, in some variations, be further modified through the application or teacher preferences 5460. Such preferences may be actively solicited, provided by a teacher via a user profile, or acquired from some other source (such as usage history and/or settings). The resources may then be arranged into one or more instructional plans 5450 based on the association among the resources, TASS, and standards and indicators, and the distribution of those TASS and standards and indicators throughout the academic schedule.

In some embodiments, teacher preferences may be omitted or included as part of an optional customization process 5470. In other embodiments, further customization 5470 may be an additional and/or substitute modification strategy outside of teacher preference application 5460. Variations of a customization approach may be optional or may be an automated feature with an opt-out capability. In some embodiments, customization may include using a resource filter of the type discussed above to generate a filtered resource list 5480 that may be used to add resources to the instructional plan 5490 and/or modify resource associations 5530 to connect resources to courses, TASS, and/or standards and indicators as part of the resource addition process. In further embodiments, customization may include removing resources from the instructional plan 5490. Upon completion of a customization process, a final instructional plan 5500 may be generated. In some variations, a customization process may be repeated by a teacher as many times as desired during the course of instruction to account for changes in student makeup, current events, additions to the resource pool, and changes in teacher preferences with respect to instructional techniques. Such customization iterations may cause a new “final” instructional plan to be generated 5500 after each iteration. The “final” plan in such a context therefore means the plan which the teacher is actively using during the course of instruction.

In some variations, the final instructional plan 5500 may be accessible to students and/or parents 5520 so that students can view and manage their individual learning plans and have immediate access to resources identified and provided by the teacher. In other variations, the resources included in the plan may be flagged or otherwise indicated as potential sources of instructional collaboration by identifying other teachers that are using or have used a particular resource 5510. In yet further variations, peer collaboration for further resource and/or plan development and refinement may also be facilitated through the identification of other teaches 5510 currently using and/or familiar with a particular resource.

Variations of systems and operating methods as described above may be implemented as specialized computer systems, web-based server-side solutions, client-server systems, and fully or partially automated data processing systems. In some embodiments, instructions and information related to the operation and use of such a system and/or method may be embodied on a non-transitory computer-readable medium so as to enable a computer to carry out the necessary operations and store or access the required data.

It should be apparent to skilled persons that variations of the systems and methods discussed herein may be applicable to any number of learning and education delivery situations and scenarios. University-level educational planning—including course and curriculum development, military educational planning and educational collaboration, vocational schools, professional development scenarios, and various certification and licensing education entities may benefit from the advantages and capabilities discussed and described herein. Yet further variations may be implemented for corporate training and education, such as courses offered to users on particular products made by a company, or ongoing training and education for employees on the internal practices, procedures, and/or systems and equipment utilized by a company. Further variations still may include standardization of and collaboration on interdisciplinary courses of education in military or manufacturing settings focused on cross-training recruits and/or employees.

The invention being thus described, it will be obvious that the same may be varied in many ways. Such variations are not to be regarded as departure from the spirit and scope of the invention, and all such modifications as would be obvious to one skilled in the art are intended to be included within the scope of the following claims.

We claim:

1. A system for creating and managing an instructional plan for a particular course of education that facilitates interdisciplinary planning, the system comprising:
a course repository section storing at least one course, said course including two or more content areas;
an indicators repository section storing at least one indicator associated with said course;
an academic success skills repository section storing at least one thinking and academic success skill (TASS), where a thinking and academic success skill is associated with said course;
a schedule repository section storing at least one unit sequence associated with at least one of said content areas, said unit sequence including two or more particular periods;
a resource repository section storing at least one resource; and
an instructional plan creator configured to create an instructional plan based on associations between said course, said TASS and said unit sequence;
wherein said TASS is associated with at least one unit sequence and at least one resource is associated with at least one content area within a particular period in the unit sequence and where at least one indicator is associated with a particular content area and a particular period in the unit sequence; and
wherein said instructional plan includes at least one associated resource.

2. A method for creating and managing an instructional plan for a particular course of education that facilitates interdisciplinary planning, the method comprising:
course providing at least one course, said course including two or more content areas;
indicator providing at least one indicator associated with said course;
skills providing at least one thinking and academic success skill (TASS), where a thinking and academic success skill is associated with said course;
schedule providing at least one unit sequence associated with at least one of said content areas, said unit sequence including two or more particular periods;
resource providing at least one resource;
creating an instructional plan based on associations between said course, said TASS and said unit sequence;
wherein said TASS is associated with at least one unit sequence and at least one resource is associated with at least one content area within a particular period in the unit sequence;
wherein at least one indicator is associated with a particular content area and a particular period in the unit sequence; and
wherein said creating includes associating at least one associated resource with said instructional plan.

3. A method of collaborative interactive academic planning, the method comprising:
establishing an overall course based on a content area, predetermined thinking and academic success skills (TASS) and a predetermined academic schedule, where the TASS are associated with the academic schedule such that individual schedule units are associated with one or more particular skills and where the TASS area associated with the content area such that one or more standards and indicators of the content area are associated with one or more particular skills;
generating a suggested resource set associated with the course by identifying resources from a resource pool, where a resource is identified for a schedule unit based on the content area and TASS associated with that schedule unit; and
generating an overall instructional plan based on the resource set, where the overall instructional plan includes an instructional plan for one or more schedule units based on the resources associated with a particular schedule unit.

4. The method of claim 3, where said generating an overall instructional plan includes applying teacher preferences to a set of suggested resources to add or remove certain resources to/from the instructional plan of a particular teacher.

5. The method of claim 4, the method further comprising identifying another teacher currently using a resource in the instructional plan and facilitating communication between the particular teacher and said another teacher.

6. A method of collaborative interactive academic planning for an educational course associated with one or more standards and indicators and having an established overall schedule, the method comprising:
identifying suggested educational resources for the course;
applying teacher preferences to the identified suggested resources;
generating an instructional plan for the course according to the schedule and including the suggested resources as modified by the applied teacher preferences.

7. The method of claim 6, the method further comprising identifying, for a teacher using the generated instructional plan, another teacher that is currently using or has previously used one or more of the resources included in the instructional plan.

8. The method of claim 6, the method further comprising customizing the generated instructional plan into a final instructional plan, where said customizing includes at least one of:
using provided customization parameters to generate a filtered resource list and adding one or more resources from the filtered resource list to the generated instructional plan; and
removing one or more resources from the generated instructional plan.

9. A data association structure for creating, managing, and maintaining associations between at least one content area, at least one time portion within an academic marking period, and at least one thinking and academic success skill, the structure comprising:
a first logical organization axis representing a sequence of time portions within the academic marking period;
a second logical organization axis representing a plurality of content areas; and
a third logical organization axis representing a plurality of thinking and academic success skills;
where a plane along the first and third logical organization axes at a defined point on the second logical axis is associated with a content plan for a content area that addresses the thinking and academic success skills in that content area for the whole marking period;
where a plane along the second and third logical organization axes at a defined point on the first logical axis is associated with an integrated plan for a time portion that addresses the content areas and related thinking and academic success skills in that time period; and
where the first, second, and third logical orientation axes are aligned to create a data cube such that a coordinate point in the cube defined by a particular time portion, content area, and thinking and academic success skill is associated with at least one resource meant to facilitate teaching of that particular thinking and academic success skill related to that particular content area at that particular time portion.
